(19) United States
(12) Patent Application Publication
(10) Pub. No.: US 2010/0023315 A1
(43) Pub. Date: Jan. 28, 2010

(54) RANDOM WALK RESTARTS IN MINIMUM ERROR RATE TRAINING

(75) Inventor: Christopher Brian Quirk, Seattle, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/179,784

(22) Filed: Jul. 25, 2008

(51) Int. Cl. G06F 17/28

(52) U.S. Cl. 704/3

(57) ABSTRACT

The claimed subject matter provides systems and/or methods that minimize error rate training for statistical machine translation. The systems can include devices that optimize a statistical machine translation model for translating between a first natural language and a second natural language by generating lists of n-best translation hypotheses and associated feature weights, optimizing the associated feature weights with respect to the lists of n-best translation hypotheses, and thereafter determining a translation quality measurement for the training sets from which the lists of n-best translation hypotheses were derived.

### BACKGROUND

Statistical machine translation (SMT) is a machine translation technique where translations are generated on the basis of statistical models. The models' feature weights are derived from the analysis of one or more bilingual text corpora, where a text corpus is a large structured set of text (e.g. usually electronically stored and processed). The statistical approach contrasts with the rule based machine translation, as well as with example based machine translation.

The ideas behind statistical machine translation (SMT) systems come from information theory. Essentially, a document is translated on the probability that a string in the native language (e.g., English) has an equivalent translation of the string in a foreign language (e.g., German). Benefits of statistical machine translation (SMT) over other techniques include better use of resources (e.g., a great deal of natural language is in machine readable format already, statistical machine translation (SMT) systems are not limited to any specific pair of languages, . . . ) and more natural translations.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The claimed subject matter in accordance with an aspect provides a system for training feature weights to minimize the error rate according to some error function for statistical machine translation. The system optimizes feature weights in a statistical machine translation model for translating between a first natural language and a second natural language, wherein a list of n-best translation hypotheses and associated feature values can be generated according to the statistical machine translation model. The system then can optimize the associated feature weights with respect to the list of n-best translation hypotheses, provided a training set from which the list of n-best translation hypotheses are derived.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that minimizes error rate training for statistical machine translation in accordance with the claimed subject matter.

FIG. 2 depicts machine-implemented system that effectuates and facilitates error rate training for statistical machine translation in accordance with an aspect of the claimed subject matter.

FIG. 3 provides a more detailed depiction of an illustrative analysis component that effectuates and facilitates minimizing error rate training for statistical machine translation in accordance with an aspect of the claimed subject matter.

FIG. 4 provides a further detailed depiction of an analysis component that effectuates and facilitates minimizing error rate training for statistical machine translation in accordance with an aspect of the claimed subject mater.

FIG. 5 provides yet a further exemplification of an illustrative analysis component that effectuates and facilitates minimizing error rate training for statistical machine translation in accordance with an aspect of the claimed subject matter.

FIG. 6 provides a further depiction of an analysis component that effectuates and facilitates minimizing error rate training for statistical machine translation in accordance with an aspect of the subject matter as claimed.

FIG. 7 provides further depiction of an illustrative analysis component that effectuates and facilitates minimizing error rate training for statistical machine translation in accordance with an aspect of the claimed subject matter.

FIG. 8 illustrates a flow diagram of a machine implemented methodology that effectuates and facilitates minimizing error rate training for statistical machine translation in accordance with an aspect of the claimed subject matter.

FIG. 9 illustrates a block diagram of a computer operable to execute the disclosed system in accordance with an aspect of the claimed subject matter.

FIG. 10 illustrates a schematic block diagram of an illustrative computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

Most current statistical machine translation (SMT) systems operate in the following manner. Given a source sentence S, the system searches for the target sentence T that maximizes some scoring function G(S, T, w), where w is a vector of N real-values. The scoring function G(S, T, w) is a linear combination of feature functions F1(S, T) to FN(S, T) defined by G(S, T, w)=w1*F1(S, T)+ . . . +wN*FN(S, T), where the feature functions can be log probabilities from models, or arbitrary real-valued features. The component that searches over different target sentences T to find the one with the maximum G(S, T, w) score is called the decoder.

Translations T can be evaluated with respect to a human translation R, often called a reference translation, to measure the quality of the translation. There are a variety of evaluation measures commonly used, including the number of words in common between T and R divided by the number of words in R; the error rate of the system would then be the number of words not in common between R and T divided by the number of words in R. The most commonly used evaluation measure for SMT systems is called BLEU, short for “Bi-Lingual Evaluation Understudy”, a method of automatic machine translation evaluation that correlates highly with human evaluation and that has little marginal cost per run. It measures the n-grams in common between system outputs and reference translations, returning a score between 0 (for a translation with nothing in common) and 1 (for a translation that matches the reference exactly). As such it is a goodness measure rather than an error rate; instead one can use the expression 1-BLEU(T, R) to measure the error rate in translations T with respect to some human reference translation R.

The feature weights w used by the decoder may be selected in a variety of ways. One common method is minimum error rate training (MERT), where the method attempts to find a set of feature weights w such that 1-BLEU(arg max_T(G(S, T, w), R) is minimized. That is, the technique tries to pick feature weights such that when the methodologies and systems disclosed and utilized herein translate some source development set S, they find a set of translations T that have maximum BLEU scores with respect to some reference translations R.

Minimum error rate training (MERT) for optimizing feature weights in statistical machine translation (SMT) models, generally produces higher translation quality scores than maximizing the conditional likelihood of a maximum entropy model using the same feature functions (picking w such that G(S, R, w) is maximized). The approach iteratively optimizes one feature weight at a time by coordinate ascent, using a line search that can take advantage of special properties of the mapping from sets of feature values to the resulting evaluation measure. The technique is notable in that the line search is guaranteed to find a global optimum along the line searched, whereas more general line search methods are guaranteed only to find a local optimum.

Optimization of one feature weight at a time, however, does not ensure that the final feature weight vector will attain a global optimum of the error rate function. Hence, the minimum error rate training (MERT) procedure is frequently augmented by employing multiple random starting points for each optimization search within the overall algorithm. It has been observed that using multiple random restarts can substantially improve the resulting model in terms of translation quality as measured by the bilingual evaluation understudy (BLEU) metric, but that training time can also increase substantially.

Nevertheless, by selecting starting points by a random walk from the last point reached by coordinate ascent, rather than by sampling from a uniform distribution, a slight additional improvement in the bilingual evaluation understudy (BLEU) score can be achieved, and is significantly faster, although still slower than training without random restarts.

While minimum error rate training for statistical machine translation (SMT) was always theoretically possible using general numerical optimization techniques, such as a downhill simplex method or Powell's method, naïve use of these techniques would require repeatedly translating a set of training sentences with hundreds or thousands of different combinations of feature weights. This is clearly impractical for most statistical machine translation (SMT) decoders, which take minutes to hours of CPU time to translate a training set of sufficient size for reliable feature weight estimation.

The minimum error rate training (MERT) approach utilized and employed herein relies on two key ideas. First, expensive statistical machine translation (SMT) decoding time can be saved by generating lists of n-best translation hypothesis, along with their feature values according to the statistical translation model, and then optimizing feature weights just with respect to those hypotheses. In this way, as many different feature weight settings as necessary can be explored without rerunning the decoder. The translation quality measurement for the training corpus can be estimated for a given point in the feature weight space by finding the highest scoring translation hypothesis, out of the current set of hypotheses for each sentence in the training set. This is typically orders of magnitude faster than rerunning the decoder for each combination of feature weights.

Since the resulting feature weights are optimized only with respect to one particular set of translation hypotheses, the decoder can actually produce a different hypothesis when run with those weights. Therefore, the minimum error rate training (MERT) approach utilized and employed herein iterates the process, running the decoder with the optimized feature weights to produce a new set of n-best translation hypotheses for each sentence in the training set, merging these with the previous sets of hypotheses, and re-optimizing the feature weights relative to the expanded hypothesis sets. This process can be repeated until no more new hypotheses are obtained for any sentence in the training set.

A further aspect of the minimum error rate training (MERT) technique is a method of numerical optimization that takes advantage of the fact that, while translation quality metrics can have continuous values, they are always applied to the discrete outputs of a translation decoder. This means that any measure of translation quality can change with variations in feature weights only at discrete points where the decoder output changes. To exploit this, the minimum error rate training (MERT) approach employs an efficient procedure for finding all the values of a single feature weight at which the highest scoring translation hypothesis changes, out of the current set for a particular sentence, keeping the other feature weights constant. By merging the list of such points for all sentences in the training set, a list is obtained of all the points at which the highest scoring hypothesis changes for any training sentence.

Relative to the fixed set of hypotheses, finding the optimal value of the feature weight on the training set for this feature weight simply requires evaluating the translation quality metric for each range of values for the feature weight between two such consecutive points. This can also be done efficiently by tracking incremental changes in the sufficient statistics for the translation quality metric as one iterates through the points where things change. The minimum error rate training (MERT) approach uses this procedure as a line search method in a simple coordinate ascent iteration through the feature weights until no additional improvement in the translation quality metric can be obtained, given the current sets of translation hypotheses.

Although the line search employed by the minimum error rate training (MERT) technique on each feature weight in turn is globally optimal, this typically is not sufficient to guarantee that the set of feature weights found by this iterative coordinate ascent facility will produce the globally optimum combination of weights for all features. To avoid getting stuck at an inferior local optimum during utilization of the procedure, it is common to initialize the optimization search over each expanded set of translation hypotheses with multiple starting points. Typically, one of these points is the best point found while optimizing over the previous set of translation hypotheses. Since additional hypotheses have been added after that point was obtained, initiating coordinate ascent from this point on the new set of hypotheses will often lead to a higher local optimum. A fixed number of additional starting points are typically selected by setting the initial value of each feature by sampling from a uniform distribution over a fixed interval or range (e.g., −1.0 to +1.0). These randomly selected points can be referred to as “random restarts”. The highest point reached by coordinate ascent from either the previous optimum or one of the random restart points is selected as the optimum for the current set of translation hypotheses.

In the random restart procedure explicated above, the random values for each feature weight are independently sampled from a uniform distribution over the range (e.g., [−1, +1]). Nevertheless, it has been observed anecdotally, that if the selected starting point produces a training set BLEU score much below the best seen up until a particular juncture in time, the coordinate ascent search from that point onwards is unlikely to take one to a point that is better than the best seen up until that juncture. Accordingly, in order to bias selection of restarting points towards better scores, the claimed subject matter can select starting points by a random walk process starting from the ending point of the last coordinate ascent search.

To effectuate and/or facilitate biasing the selection of restarting points, a series of cautious perambulations in feature weight space guided by training set BLEU can be undertaken. The selection can commence by locating the ending point of the last coordinate ascent search; this point can be denoted as \vec{w}⁽⁰⁾. Each progression thereafter updates feature weights in a manner inspired by Metropolis-Hastings sampling. Starting from the current feature weight vector \vec{w}⁽ⁱ⁾, the claimed subject matter can sample a small update from a multivariate Gaussian distribution with a mean of 0 and the diagonal covariance matrix σ² I. This update can be added to the current value to produce a new potential feature weight vector. The BLEU scores for the old and the new feature weight vector can be compared. The new feature weight vector is generally always accepted if the BLEU score on the training set is improved; however if the BLEU score drops, the new vector is still accepted but with a probability that depends on how close the new BLEU score is to the previous one. After a fixed number of progressions, the walk can be terminated, and the claimed subject matter produces a value to use as the initial point for the next round of coordinate ascent.

Nevertheless, there can be a few wrinkles. First, in order to ensure that the scores do not fall precipitously during the random walk, the claimed matter can establish a baseline of m=BLEU(\vec{w}⁽⁰⁾)−0.005 (e.g., ½ BLEU point below the initial value) and not allow a perturbation to go below this baseline value. To ensure this, each progression can advance as follows:

$${\vec{d}}^{( i )} \sim GAUSSIAN ( 0 , I \cdot {σ}^{2} )$$

$${\vec{v}}^{( i )} = {\vec{w}}^{( i )} + {\vec{d}}^{( i )}$$

$${u}^{( i )} \sim UNIFORM ( 0 , 1 )$$

$${\vec{w}}^{( i + 1 )} = \{ \begin{matrix}{\vec{v}}^{( i )} & if \frac{BLEU ( {\vec{v}}^{( i )} ) - m}{BLEU ( {\vec{w}}^{( i )} ) - m} \geq {u}^{( i )} \\ {\vec{w}}^{( i )} & otherwise\end{matrix}$$

With this update rule, the claimed matter knows that \vec{w}⁽ⁱ⁺¹⁾ will never go below m, since the initial value is not below m, and any advancement moving below m will result in a negative ratio and therefore not be accepted.

To this point, σ² has been left as a free parameter. Nevertheless, an initial value of 0.001 can be used and experience indicates that utilization of such a value ensures that the claimed matter performs well, even though, in general, it can result in progressions that are consistently too small (e.g., so that only a very local neighborhood is explored) or too large (e.g., so that the vast majority of progressions are rejected). In order to overcome this therefore, the claimed matter can devote the first half of the perturbations to “burn-in”; tuning σ² so that approximately 60% of the progressions are accepted, for instance. During the burn-in, the claimed matter can determine the acceptance rate after each perturbation. If it is less than 60%, the claimed matter can multiply σ² by 0.99; if greater, the claimed matter can multiply by 1.01, for example.

As a final twist in the selection of the point used for the next iteration of coordinate ascent, rather than using the final point of the random walk \vec{w}⁽ⁿ⁾, the claimed matter can return the feature weight vector that achieved the highest BLEU score after burn-in: \vec{w}*=arg max_{\vec{w}}_{⁽ⁱ⁾}_{,n/2<i≦n} BLEU(\vec{w}). This ensures that the new feature weight vector has a relatively high objective function value yet is likely very different from the initial point.

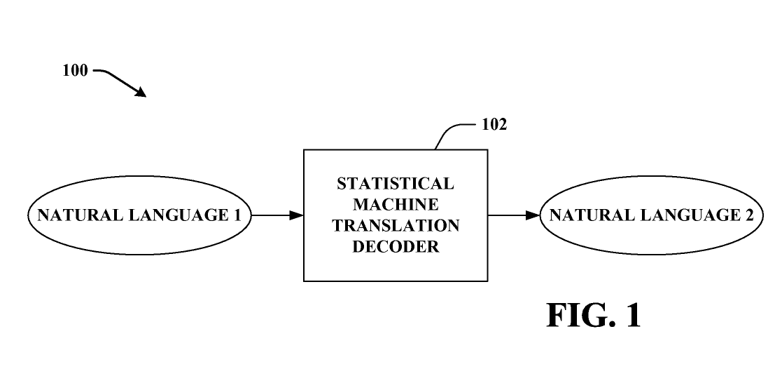

FIG. 1 depicts an illustrative machine-implemented system 100 that minimizes error rate training for statistical machine translation in accordance with the claimed subject matter. As illustrated, system 100 can include statistical machine translation decoder 102 that can effectuate and/or facilitate minimum error rate training (MERT) for optimizing feature weights in statistical machine translation (SMT) models. Statistical machine translation decoder 102 can be implemented entirely in hardware and/or a combination of both hardware and/or software. Moreover, statistical machine translation decoder 102 can be incorporated within and/or associated with other compatible components. Statistical machine translation decoder 102 can be any type of device, facility, and/or instrument of conversion that includes a processor. Illustrative mechanisms, machines, devices, facilities, and/or instruments that can comprise statistical machine translation decoder 102 can include Tablet PCs, server class computing machines, laptop computers, notebook computers, desktop computers, cell phones, smart phones, consumer appliances and/or instrumentation, industrial devices and/or components, hand-held devices, personal digital assistants, multimedia Internet enabled phones, Global Positioning Systems (GPS), USB flash devices, multimedia players, televisions, and the like.

Statistical machine translation decoder 102 can receive input in the form of one natural language (e.g., German, French, Japanese, Spanish, English, etc), process the received input language using a statistical translation model that typically can have the standard eight features (e.g., language 1-to-language 2 and language 2-to-language 1 phrase translation log probabilities, language 1-to-language 2 and language 2-to-language 1 phrase translation lexical scores, language 2 model log probabilities, phrase counts, language 2 word counts, and distortion scores), and output a translation of the first language into a disparate second language.

In order to effectuate the foregoing, statistical machine translation decoder 102 can iteratively optimize one feature weight at a time by coordinate ascent, using a line search that can take advantage of special properties of the mapping from sets of feature weights to the resulting translation quality measurement. The line search technique utilized by statistical machine translation decoder 102 is notable in that the line search is guaranteed to find the global optimum, whereas more general line search methods utilized by previous statistical machine translation decoders typically only find local optima.

Global optimization of one feature weight at a time, nevertheless, does not ensure global optimization of all feature weights simultaneously. Accordingly, statistical machine translation decoder 102 can augment the minimum error rate training (MERT) procedure utilized therein by employing multiple random starting points for each optimization search. Nevertheless, it should be noted, without limitation, that statistical machine translation decoder 102 can actuate the minimum error rate training (MERT) procedure with and without multiple starting points for the optimization search, selecting initial starting points randomly from a uniform distribution. However, it has been observed that using multiple random restarts can yield substantial improvements in the resulting model in terms of translation quality as measured by the bilingual evaluation understudy (BLEU) metric (e.g., a method for evaluating the quality of text which has been translated from one natural language to another natural language using machine translation). Moreover, by selecting starting points by random walk from the last point reached by coordinate ascent, rather than sampling from a uniform distribution, a slight additional improvement in the bilingual evaluation understudy (BLEU) metric can be achieved.

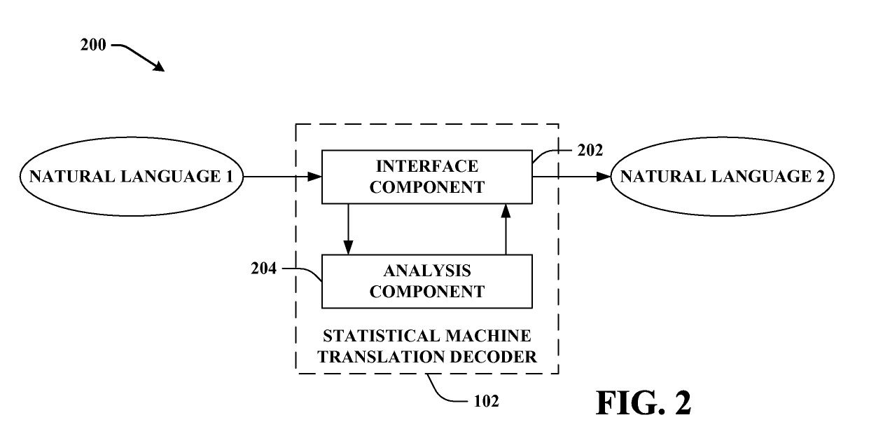

Turning now to FIG. 2 that provides further illustration 200 of a statistical machine translation decoder 102 that minimizes error rate training for statistical machine translation in accordance with an aspect of the claimed matter. As illustrated statistical machine translation decoder 102 can include interface component 202 (hereinafter referred to as “interface 202”) that can receive and/or distribute, communicate, and/or partake in data interchange with a plurality of disparate sources and/or components. For instance, interface 202 can receive and/or transmit data from, or to, a multitude of sources, such as, for example, data associated with analysis component 204 as well as receive input in the form of natural language text files or human voice samples in a first language (e.g., natural language 1) and disseminate output in the form of natural language text or voice samples in a disparate second natural language (e.g., natural language 2). Additionally and/or alternatively, interface 202 can obtain and/or receive data associated with usernames and/or passwords, sets of encryption and/or decryption keys, client applications, services, users, clients, devices, and/or entities involved with a particular transaction, portions of transactions, and thereafter can convey the received or otherwise acquired information to analysis component 204, for subsequent and further utilization, processing, and/or analysis.

To facilitate its objectives, interface 202 can provide various adapters, connectors, channels, communication pathways, etc. to integrate the various components included in system 200, and more particularly, statistical machine translation decoder 102, into virtually any operating system and/or database system and/or with one another. Additionally and/or alternatively, interface 202 can provide various adapters, connectors, channels, communication modalities, and the like, that can provide for interaction with the various components that can comprise system 200, and/or any other component (external and/or internal), data, and the like, associated with system 200.

The minimum error rate training (MERT) approach utilized and employed by analysis component 204 relies on two key ideas. First, expensive statistical machine translation (SMT) decoding time can be saved by generating lists of n-best translation hypotheses, along with their feature values according to the statistical translation model, and then optimizing feature weights just with respect to those hypotheses. In this way, analysis component 204 can explore as many different feature weight settings as necessary without rerunning the decoder. The translation quality measurement for the training corpus can be estimated for a given point in the feature weight space by finding the highest scoring translation hypothesis, out of the current set of hypotheses for each sentence in the training set. Utilization of this approach is typically orders of magnitude faster than rerunning the decoder to each combination of feature weights.

Since the resulting feature weights are optimized only for one particular set of translation hypotheses, analysis component 204 can actually produce a different hypothesis when run with those weights. Therefore, the minimum error rate training (MERT) approach utilized and employed by analysis component 204 can integrate the process, running the decoder with the optimize feature weights to produce a new set of n-best translation hypotheses for each sentence in the training set, merging piece with the previous sets of hypotheses, and re-optimizing the feature weights relative to be expanded hypothesis sets. As will be appreciated, this process can be repeated by analysis component 204 until no more new hypotheses are obtained for any sentence in the training set.

Further, analysis component 204 can also utilize a method of numerical optimization that takes advantage of the fact that, while translation quality metrics can have continuous values, they typically are applied to discrete outputs from translation decoders. The implication being that any measure of translation quality can change with variations in feature weights at discrete points where the decoder output changes. In order to overcome this, analysis component 204 can employ an efficient procedure for finding all the values of a single feature weight at which the highest scoring translation hypothesis changes, out of the current set for a particular sentence, keeping the other feature weights constant. By merging the list of such points for all the sentences in the training set, a list can be obtained of all the points at which the highest scoring hypothesis changes for any training sentence.

Relative to the fixed set of hypotheses, analysis component 204 can find the optimal value of the feature weight on the training set for the feature weight by evaluating the translation quality metric for each range of values for the feature weight between two such consecutive points. Additionally and/or alternatively, analysis component 204 can also find the optimal value of the feature weight on the training set for a particular feature weight by tracking incremental changes in the sufficient statistics for the translation quality metric as it iterates through the points where things change. Analysis component 204 can use this procedure as a line search method in a simple coordinate ascent iteration through the feature weights until no additional improvement in the translation quality metric can be obtained, given the current sets of translation hypotheses.

Although a line search employed by the analysis component 204 in connection with each feature weight in turn is globally optimal, this typically is not sufficient to guarantee that the set of feature weights found by this iterative coordinate ascent facility will produce the globally optimum combination of weights for all features. To circumvent this outcome (e.g., getting stuck at an inferior local optima during utilization of the procedure) it is common to initialize the optimization search of the each expanded set of translation hypotheses with multiple starting points. Typically, one of these points is the best point found while optimizing over the previous set of translation hypotheses. Since additional hypotheses can have been added up to that point was obtained, initiating coordinate ascent from this point on the new set of hypotheses will often lead to a higher local optimum. Accordingly, analysis component 204 can select a fixed number of additional starting points by setting the initial value of each feature and sampling from a uniform distribution over a fixed interval (e.g., −1 to +1). These randomly selected points can be referred to as “random restarts”. Analysis component 204 can locate the optimum for the current set of translation hypotheses by selecting the highest point reached by coordinate ascent from either of the previous optimum or one of the random restart points.

As has been stated in connection with the random restart procedure, the random values for each feature weight are independently sampled from a uniform distribution over the range (e.g. −1 to +1). But it has been observed that if the selected starting point produces a training set BLEU score much below the best seen up until a particular point in time, the coordinate ascent search from that point onwards is unlikely to take one to a point that is better than the best seen up until that juncture. Accordingly, analysis component 204 can bias selection of restarting points towards better scores by selecting starting points by random walk process starting from the ending point of the last coordinate ascent search.

Analysis component 204 can effectuate or actuate biasing the selection of restarting points through a series of cautious perambulations in feature weight space guided by training set BLEU. For instance, analysis component 204 can actuate selection of restarting points by locating the ending point of the last coordinate ascent search (e.g., \vec{w}⁽⁰⁾). Each progression effectuated thereafter by analysis component 204 can update preferences in a manner inspired by Metropolis-Hastings sampling. Thus, analysis component 204, starting from the current feature weight vector (e.g., \vec{w}⁽ⁱ⁾) can sample a small update from a multivariate Gaussian distribution, for example, with a mean of 0 and the diagonal covariance matrix I·σ². Analysis component 204 can add the update to the current value to produce a new potential feature weight vector. The BLEU scores for the old and the new feature weight vector can be compared by analysis component 204. The new feature weight vector is generally always accepted by analysis component 204 if the BLEU score on the training set is improved; however if the BLEU score drops, the new vector is still accepted by analysis component 204, but with a probability that depends on how close the new BLEU score is to the previous one. After a fixed number of progressions, analysis component 204 can terminate the walk and generate a value that can be used by analysis component 204 as the initial point for the next round of coordinate ascent.

There nonetheless can be a number of intricacies involved and a certain degree of artifice required of the analysis component 204 in overcoming these complexities. First, in order to ensure that the scores do not fall precipitously during the random walk, the analysis component 204 can establish a baseline of m=BLEU(\vec{w}(0))−0.005 and not allow a perturbation to go below this baseline value. The analysis component 204 can ensure this by advancing each progression as follows:

$${\vec{d}}^{( i )} \sim GAUSSIAN ( 0 , I \cdot {σ}^{2} )$$

$${\vec{v}}^{( i )} = {\vec{w}}^{( i )} + {\vec{d}}^{( i )}$$

$${u}^{( i )} \sim UNIFORM ( 0 , 1 )$$

$${\vec{w}}^{( i + 1 )} = \{ \begin{matrix}{\vec{v}}^{( i )} & if \frac{BLEU ( {\vec{v}}^{( i )} ) - m}{BLEU ( {\vec{w}}^{( i )} ) - m} \geq {u}^{( i )} \\ {\vec{w}}^{( i )} & otherwise\end{matrix}$$

By utilizing this update rule analysis component 204 can be certain that \vec{w}⁽ⁱ⁺¹⁾ will never go below n, since the initial value is not below m, and any advancement moving below m will result in a negative ratio and therefore not be acceptable.

As will have been observed, up until this point σ² has been left as a free parameter by the analysis component 204. An initial value of 0.001, for example, can be used and experience indicates that utilization by analysis component 204 of such a value ensures good performance, even though, in general, it can result in progressions that are consistently too small or too large. In order to overcome this therefore, analysis component 204 can devote the first half of the perturbations to tuning the various parameters so that approximately 60% of the progressions are accepted, for instance. During this tuning analysis component 204 can determine the acceptance rate after each perturbation. If it is less than 60%, the analysis component 204 can multiply σ² by 0.99; if greater, the analysis component 204 can multiply by 1.01, for example.

As a further intricacy in the selection of the point used by analysis component 204 for the next iteration of coordinate ascent, rather than using the final point of the random walk \vec{w}⁽ⁿ⁾, the analysis component 204 can return the feature weight vector that achieved the highest BLEU score after tuning (e.g., \vec{w}*=arg max_{\vec{w}}_{⁽ⁱ⁾}_{,n/2<i≦n} BLEU(\vec{w})). This ensures that the new feature weight vector has a relatively high objective function value yet is likely very different from the initial point.

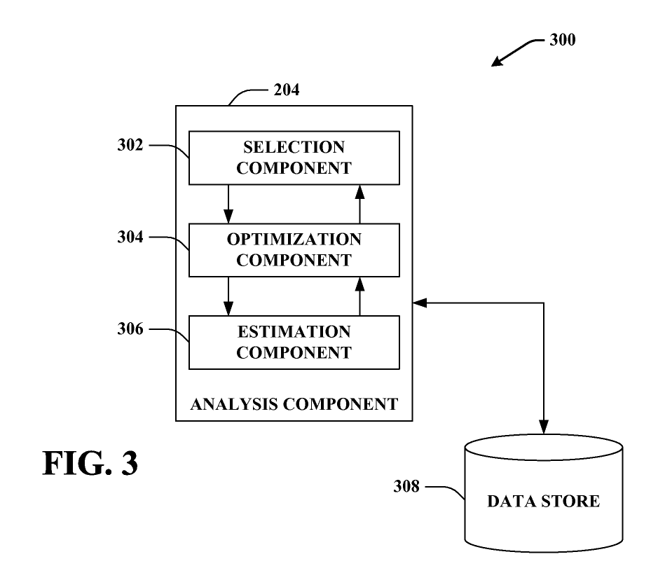

FIG. 3 provides a more detailed depiction 300 of an illustrative analysis component 204 that effectuates and/or facilitates minimization of error rate training for statistical machine translation in accordance with an aspect of the claimed matter. As illustrated, analysis component 204 can include selection component 302 that generates and/or identifies list of n-best translation hypotheses along with feature values according to a statistical translation model. Additionally, analysis component 204 can also include optimization component 304 that can optimize feature weights with respect to the identified n-base translation hypotheses identified by selection component 302. By acting in concert selection component 302 and optimization component 304 can explore as many different feature weight settings as necessary without having to rerun the decoder. The translation quality measurement for the training corpus can then be estimated by estimation component 306 for a given point in the feature weight space by finding the highest scoring translation hypothesis, out of the current set of hypotheses for each sentence in the training set typically persisted or associated with store 308.

In relation to store 308, it can include any suitable data necessary for analysis component 204 to facilitate it aims. For instance, store 308 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate networks, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information obtained from the disparate network, ratings from a website, a credit score, geographical location, a donation to charity, or any other information related to software, applications, web conferencing, and/or any suitable data related to transactions, etc.

It is to be appreciated that store 308 can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 308 of the subject systems and methods is intended to comprise, without being limited to, these and any other suitable types of memory. In addition, it is to be appreciated that store 308 can be a server, a database, a hard drive, and the like.

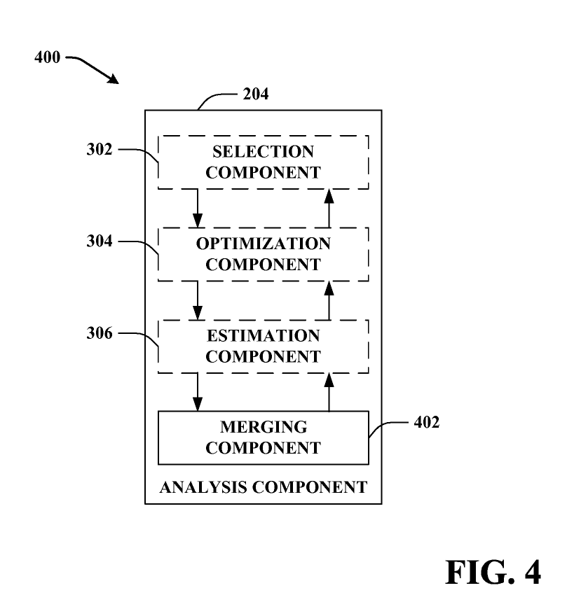

FIG. 4 provides yet further depiction 400 of the analysis component 204 that facilitates and/or effectuates minimization of error rate training for statistical machine translation in accordance with an aspect of the claimed subject matter. Since the facilities and functionalities of selection component 302, optimization component 304, and/or estimation component 306 have been discussed above, a detailed description of such features has been omitted to avoid needless repetition and for the sake of brevity and conciseness of exposition. Nonetheless, in addition to the foregoing already discussed components, analysis component 204 can also include merging component 402.

Since the resulting feature weights provided through utilization of selection component 302, optimization component 304, and/or estimation component 306 are optimized for one particular set of translation hypotheses, analysis component 204 can actually produce a different hypothesis when run with those weights. Thus, analysis component 204 can reiterate the process whereby selection component 302 can be supplied with the optimized feature weights to produce a new set of n-best translation hypotheses for each sentence in the training set (e.g., supplied by, or persisted on, store 308). This new set of n-best translation hypotheses can then be accreted with previous sets of hypotheses by merging component 402 and thereafter optimization component 304 can be employed to re-optimize the feature weights relative to the expanded hypotheses sets. This iterative process of employing selection component 302 to produce a new set of n-best translation hypotheses for each sentence in the training set, agglomerating the new set of n-best translation hypotheses generated by selection component 302 to previous sets of hypotheses by merging component 402 and utilizing optimization component 304 to re-optimize the feature weights relative to the expanded hypotheses sets can be repeated until no more hypotheses are obtained from any sentence in the training set.

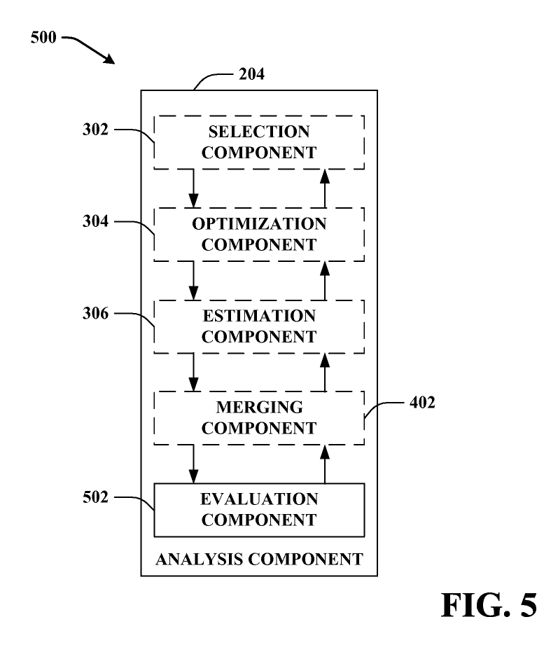

FIG. 5 provides further exemplification 500 of the analysis component 204 that effectuates and/or facilitates minimizing error rate training for statistical machine translation in accordance with an aspect of the claimed matter. As illustrated analysis component 204 can include selection component 302, optimization component 304, estimation component 306, and merging component 402, exposition of which has been made in connection with FIG. 3 and FIG. 4 above. Further, analysis component 204 can also include evaluation component 502 that can find the optimal value of the feature weight on a training set for a particular feature weight by evaluating the translation quality metric for each range of values for the feature weight between two consecutive points.

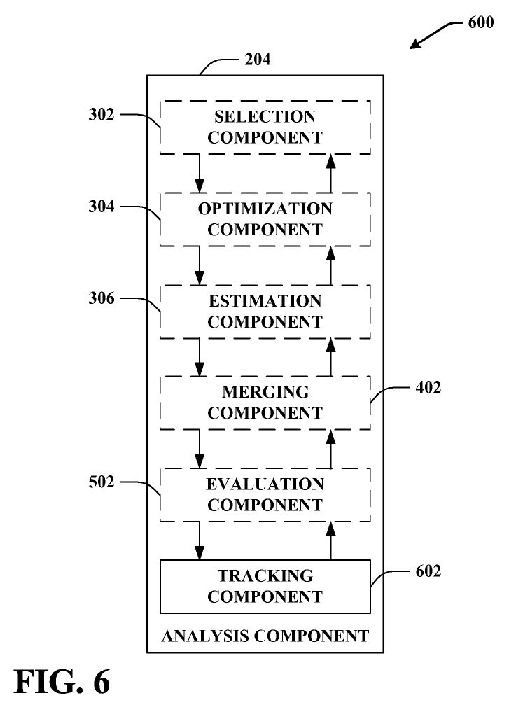

FIG. 6 provides yet another depiction 600 of the analysis component 204 that effectuates and/or facilitates minimization of error rate training for statistical machine translation in accordance with an aspect of the claimed subject matter. Once again and as illustrated, analysis component 204 can include selection component 302, optimization component 304, estimation component 306, and merging component 402, explication of which has been made in connection with FIG. 3 and FIG. 4 above. Additionally, analysis component 204 can include tracking component 602 that can be utilized in conjunction with evaluation component 502 or as an alternative to evaluation component 502. Tracking component 602 can be utilized to track incremental changes in the sufficient statistics for the translation quality metric as analysis component 204 iterates through the point where things change.

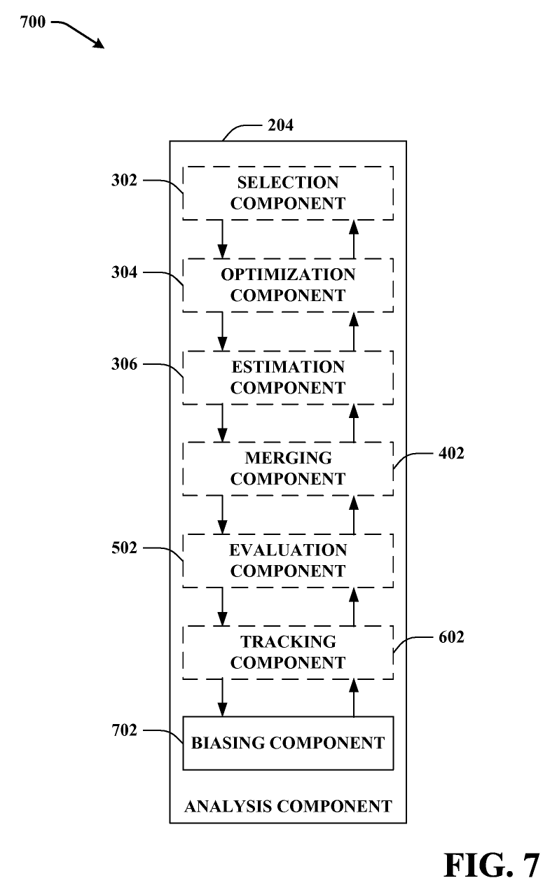

FIG. 7 provides further depiction 700 of the analysis component 204 that facilitates and/or effectuates minimizing error rate training for statistical machine translation in accordance with an aspect of the claimed subject matter. As illustrated analysis component 204 can include biasing component 702 that can perform a series of cautious perambulations in feature weight space guided by training set BLEU. The selection by biasing component 702 can commence by locating the ending point of the last coordinate ascent search; this point can be denoted as \vec{w}⁽⁰⁾. Each progression by biasing component 702 thereafter updates feature weights in a manner inspired by Metropolis-Hastings sampling. Starting from the current feature weight vector \vec{w}⁽ⁱ⁾, biasing component 702 can sample a small update from a multivariate Gaussian distribution with a mean of 0 and the diagonal covariance matrix I·σ². This update can be added by biasing component 702 to the current value to produce a new potential feature weight vector. The BLEU scores for the old and the new feature weight vector can thereafter be compared. The new feature weight vector is generally always accepted if the BLEU score on the training set is improved; however if the BLEU score drops, the new vector is still accepted but with a probability that depends on how close the new BLEU score is to the previous one. After a fixed number of progressions, the walk can be terminated, and the biasing component 702 can produce a value to use as the initial point for the next round of coordinate ascent.

Nevertheless, there can be intricacies. First, in order to ensure that scores do not fall precipitously during the random walk, biasing component 702 can establish a baseline of m=BLEU(\vec{w}⁽⁰⁾)−0.005 and not allow a perturbation to go below this baseline value. To ensure this, each progression can advance as follows:

$${\vec{d}}^{( i )} \sim GAUSSIAN ( 0 , I \cdot {σ}^{2} )$$

$${\vec{v}}^{( i )} = {\vec{w}}^{( i )} + {\vec{d}}^{( i )}$$

$${u}^{( i )} \sim UNIFORM ( 0 , 1 )$$

$${\vec{w}}^{( i + 1 )} = \{ \begin{matrix}{\vec{v}}^{( i )} & if \frac{BLEU ( {\vec{v}}^{( i )} ) - m}{BLEU ( {\vec{w}}^{( i )} ) - m} \geq {u}^{( i )} \\ {\vec{w}}^{( i )} & otherwise\end{matrix}$$

With this update rule, biasing component 702 can be assured that \vec{w}⁽ⁱ⁺¹⁾ will never go below n, since the initial value is not below m, and any advancement moving below m will result in a negative ratio and therefore not be accepted.

To this point, σ² has been left as a free parameter. Nevertheless, an initial value of 0.001 can be used even though, in general, it can result in progressions that are consistently too small (e.g., so that only a very local neighborhood is explored) or too large (e.g., so that the vast majority of progressions are rejected). In order to overcome this therefore, biasing component 702 can devote the first half of the perturbations to “burn-in”; tuning σ² so that approximately 60% of the progressions are accepted, for instance. During the burn-in, biasing component 702 can ascertain the acceptance rate after each perturbation. If it is less than 60%, biasing component can multiply σ² by 0.99; if greater, biasing component can multiply by 1.01, for example.

As a final twist in the selection of the point used for the next iteration of coordinate ascent, rather than using the final point of the random walk \vec{w}⁽ⁿ⁾, biasing component 702 can return the feature weight vector that achieved the highest BLEU score after burn-in: \vec{w}*=arg max_{\vec{w}}_{⁽ⁱ⁾}_{,n/2<i≦n} BLEU(\vec{w}). This ensures that the new feature weight vector has a relatively high objective function value yet is likely very different from the initial point.

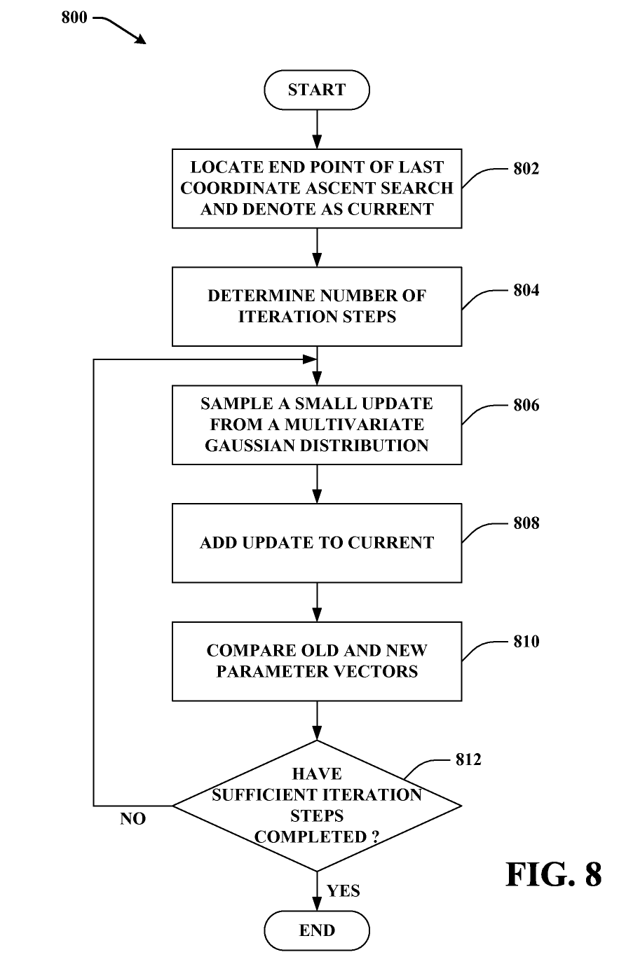

In view of the illustrative systems shown and described supra, methodologies that may be implemented in accordance with the disclosed subject matter will be better appreciated with reference to the flow chart of FIG. 8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 8 provides depiction of an illustrative methodology 800 that effectuates and/or facilitates minimizing error rate training for statistical machine translation in accordance with an aspect of the claimed subject matter. Method 800 can commence at 802 where an end point of the last coordinate ascent search can be located and denoted as being the current point. At 804 a determination can be made as to the number of iteration steps that should be performed by method 800 in order to optimize feature weights in statistical machine translation models. At 806 a small sample from a multivariate Gaussian distribution can be taken, and a 808 the update can be added to the current point. At 810 the old and new feature weight vectors can be compared after which method 800 can proceed to 812. At 812 a determination can be made as whether or not sufficient iteration steps have been completed. If it is ascertained at 812 that an insufficient number of iterative steps have been completed (e.g., NO) method 800 can cycle back to 806, otherwise where sufficient iterative steps have completed (e.g., YES) method 800 can terminate.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

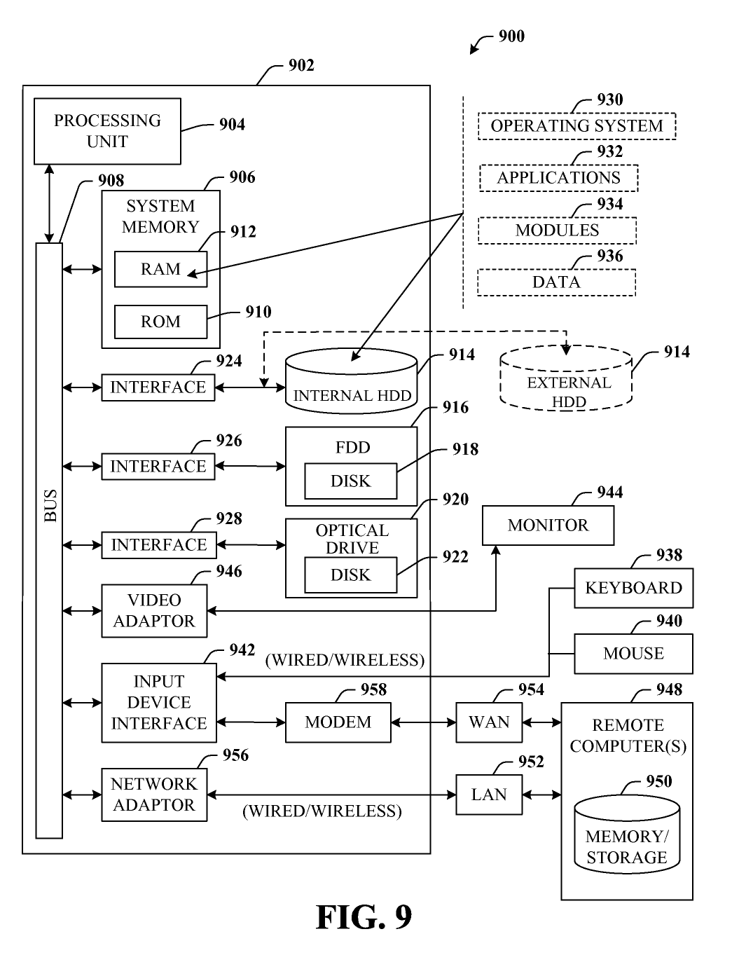

Referring now to FIG. 9, there is illustrated a block diagram of a computer operable to execute the disclosed system. In order to provide additional context for various aspects thereof, FIG. 9 and the following discussion are intended to provide a brief, general description of a suitable computing environment 900 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 9, the illustrative environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is to be appreciated that the claimed subject matter can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1094 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are illustrative and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10BaseT wired Ethernet networks used in many offices.

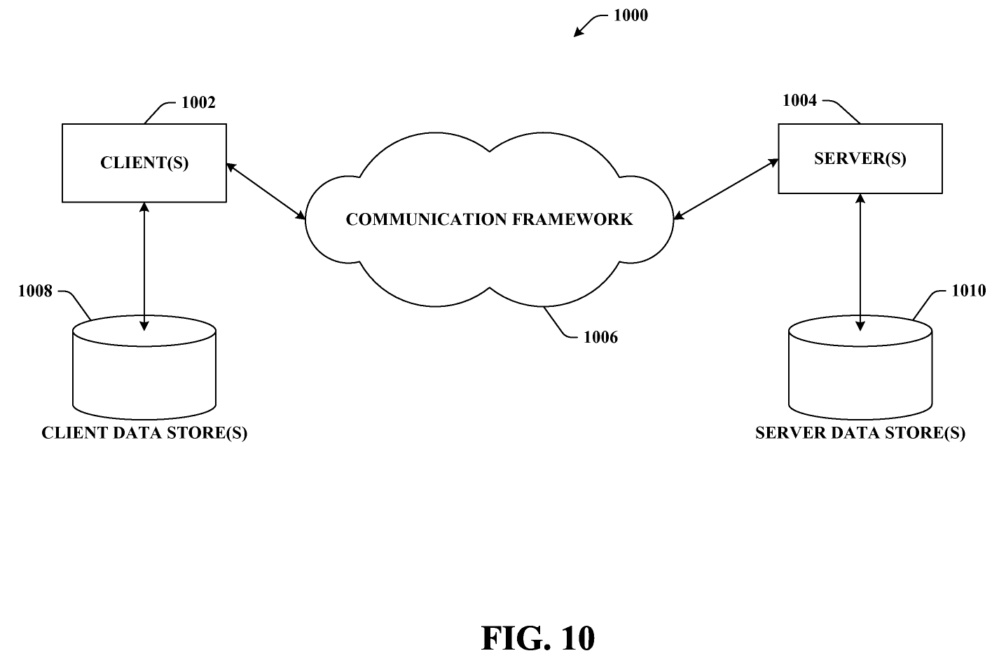

Referring now to FIG. 10, there is illustrated a schematic block diagram of an illustrative computing environment 1000 for processing the disclosed architecture in accordance with another aspect. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system implemented on a machine that minimizes error rate training for statistical machine translation, comprising:
a component that optimizes a statistical machine translation model for translating a first natural language input to a second natural language output, the component generates a list of n-best translation hypotheses and associated feature function values according to the statistical machine translation model and optimizes the associated feature weights with respect to the list of n-best translation hypotheses, the component determines a translation quality measurement for a training set from which the list of n-best translation hypotheses are derived, the translation quality measurement ascertained by finding a highest scoring translation hypothesis from the n-best translation hypotheses for each sentence included in the training set; and
an interface that receives the first natural language input and distributes the second natural output.

2. The system of claim 1, the first natural language input includes one or more of a voice sample, a document written in a first language, first natural language to second natural language and second natural language to first natural language phrase translation log probabilities, first natural language to second natural language and second natural language to first natural language phrase translation lexical scores, second natural language model log probabilities, second natural language phrase counts, second natural language word counts, or a second natural language distortion score.

3. The system of claim 1, the training set includes a M-sentence-pair development set, M denotes an integer greater than one.

4. The system of claim 1, the component generates a new list of n-best translation hypotheses for each sentence in the training set based at least in part on the optimized associated feature weights.

5. The system of claim 4, the component merges the new list of n-best translation hypotheses with the list of n-based translation hypotheses.

6. The system of claim 4, the component re-optimizes the associated feature weights relative to expanded hypotheses sets that include the new list of n-best translation hypotheses for each sentence in the training set.

7. The system of claim 1, the component relative to a fixed set of hypotheses finds an optimal value of the associated feature weights by evaluating the translation quality measurement for each of a range of values for the associated feature weights between two consecutive points.

8. The system of claim 1, the component relative to a fixed set of hypotheses identifies an optimal value of the associated feature weights by tracking incremental changes associated with the translation quality measurement.

9. A machine implemented method that minimizes error rate training for statistical machine translation, comprising:
locating an ending point of a last coordinate ascent search;
sampling a small update from a multivariate probability distribution;
adding the small update to the ending point of the last coordinate ascent search to produce a new potential feature weight vector;
at least one of accepting the new potential feature weight vector based on a comparison of a bilingual evaluation understudy (BLEU) score associated with the new potential feature weight vector and the bilingual evaluation understudy (BLEU) score associate with an old feature weight vector associated with the ending point or accepting the new potential feature weight vector with a probability based at least in part on a proximity that the bilingual evaluation understudy (BLEU) score associated with the new potential feature weight vector has with the bilingual evaluation understudy (BLEU) score associated with the old feature weight vector;
repeating the locating, the sampling, the adding and the accepting for a fixed number of repetitions; and
producing a value utilized as an initial point for a new round of coordinate ascent search.

10. The method of claim 9, further comprising establishing a baseline value below which the bilingual evaluation understudy (BLEU) score associated with the new potential feature weight vector is prevented from falling.

11. The method of claim 9, the multivariate probability distribution has a mean of zero and a diagonal covariance matrix of I·σ².

12. The method of claim 9, further comprising tuning a variance parameter to ensure an acceptance rate range between 40% to 70%.

13. The method of claim 9, the producing further comprising returning the new feature weight vector that achieved a maximal bilingual evaluation understudy (BLEU) score as the value.

14. A system that minimizes error rate training for statistical machine translation, comprising:
means for optimizing a statistical machine translation model to translate from a first natural language to a second natural language;
means for generating a list of n-best translation hypotheses and associated feature weights;
means for optimizing the associated feature weights in relation to the list of n-best translation hypotheses; and
means for determining a translation quality measurement for a training set from which the list of n-best translation hypotheses is derived.

15. The system of claim 14, the first natural language and the second natural language are disparate natural languages.

16. The system of claim 14, the means for generating creates a new list of n-best translation hypotheses for each sentence in the training set based at least in part on the optimized associated feature weights.

17. The system of claim 16, further comprising means for merging the new list of n-best translation hypotheses with the list of n-best translation hypotheses to create an expanded hypotheses set.

18. The system of claim 17, the means for optimizing the associated feature weights re-optimizes the associated feature weights relative to the expanded hypotheses set.

19. The system of claim 14, further comprising means for finding an optimal value of the associated feature weights by evaluating a translation quality measurement for each of a range of values for the associated feature weights between two consecutive points

20. The system of claim 14, further comprising means for identifying an optimal value for the associated feature weights by tracking incremental changes associated with a translation quality measurement.
